(19) United States
(12) Patent Application Publication
(10) Pub. No.: US 2026/0147095 A1
(43) Pub. Date: May 28, 2026

(54) HYDROPHOBIC LIDAR COVER AND MANUFACTURING METHOD THEREOF

(71) Applicants: HYUNDAI MOTOR COMPANY, Seoul (KR); KIA CORPORATION, Seoul (KR); Gwangju Institute of Science and Technology, Gwangju (KR)

(72) Inventors: Sae-Ah KIM, Hwaseong-si (KR); Kyoung-Chun KWEON, Hwaseong-si (KR); Gi-Heon JEONG, Hwaseong-si (KR); You-Hoon PARK, Hwaseong-s (KR); Ju-Hyeong LEE, Gwangju (KR); Gyu-Rin KIM, Incheon (KR); Hyeon-Ho JEONG, Gwangju (KR)

(21) Appl. No.: 19/098,484

(22) Filed: Apr. 2, 2025

(30) Foreign Application Priority Data
Nov. 25, 2024 (KR) 10-2024-0169265

(51) Int. Cl. G01S 7/481; G02B 1/00; G02B 1/18

(52) U.S. Cl. CPC G01S 7/4813; G02B 1/002; G02B 1/18

(57) ABSTRACT

A hydrophobic lidar cover includes a base plate, and a composite thin film deposited on the base plate. The composite thin film includes metal nanoparticles dispersed in a dielectric material. The dielectric material includes at least one of SiO₂, TiO₂, ZnO, HfO₂, or MgF₂, and the metal nanoparticles include at least one of Al, Cu, Pt, Ag, Ni, Au, Pd, or Mg. The hydrophobic lidar cover may help prevent contamination by water-based contaminants without degrading near-infrared transmission performance.

### CROSS-REFERENCE TO RELATED APPLICATION

This application claims priority to Korean Patent Application No. 10-2024-0169265, filed on Nov. 25, 2024, which is incorporated herein by reference in its entirety.

### TECHNICAL FIELD

The present disclosure relates to a light detection and ranging (lidar) cover and, more particularly, to a lidar cover having hydrophobic properties and a method of manufacturing the lidar cover.

### BACKGROUND

Light detection and ranging (lidar) is a sensor that recognizes surroundings thereof through the transmission and reception of near-infrared light. For example, a lidar includes transmission and reception elements, various optical components (mirrors, lenses, or the like), a housing, and a cover for protection. In particular, the cover may affect the performance of the lidar in some aspects because the cover interferences with the optical path.

For example, the near-infrared transmission performance of the cover may affect the performance of the lidar. Lidar emits near-infrared light (typically light having a wavelength of 905 nm), and detects reflected light after the light hits an object and is reflected therefrom to recognize the distance to the object and the shape of the object. Therefore, to ensure accurate detection, the light reception element may be configured to receive as much light as possible to reduce optical loss in the lidar cover. In other words, the optical properties of the lidar cover, especially the transmittance in the near-infrared range, should be high.

In some cases, contamination of the cover may affect the performance of the lidar. For instance, lidar covers may be contaminated by various external factors (dust, snow, rain, or the like). In particular, water absorbs a large amount of near-infrared light, so lidars are vulnerable to water-based contaminants such as snow and rain. In some cases, cleaning technologies may be applied, e.g., various heating wires, water-repellent coatings, or the like.

In some cases, the temperature difference between the inside and outside of the lidar may cause fogging on the cover surface. In some cases where a heating wire technique is used, the near-infrared transmission performance may be decreased, a separate system configuration may be included, and power efficiency may be decreased because the technique uses electric power. In some cases, water droplets from snow, rain, or the like may often form on the surface of the cover, which may be reduced by applying a separate water-repellent coating to the cover. However, the separate water-repellent coating may reduce the near-infrared transmission performance and be inefficient due to a separate process being added.

### SUMMARY

The present disclosure describes a hydrophobic lidar cover that helps reduce or prevent contamination by water-based contaminants without degrading near-infrared transmission performance, and a manufacturing method thereof.

According to one aspect of the subject matter described in this application, a hydrophobic sensor cover includes a base plate and a composite thin film deposited on the base plate, where the composite thin film comprises metal nanoparticles that are dispersed in a dielectric material.

Implementations according to this aspect can include one or more of the following features. For example, the dielectric material may include at least one of SiO₂, TiO₂, ZnO, HfO₂, or MgF₂. In some examples, the metal nanoparticles may include a plasmonic metal. For instance, the metal nanoparticles may include at least one of Al, Cu, Pt, Ag, Ni, Au, Pd, or Mg.

In some implementations, the dielectric material may include SiO₂, and the metal nanoparticles may include Cu.

In some implementations, the composite thin film may have a metastructure including nano-columns that are arranged in the composite thin film. For example, the metastructure may include a self-assembly monolayer (SAM) film that is deposited on a surface of the metastructure.

In some examples, a volume of the metal nanoparticles is 15±5% of a total volume of the dielectric material. In some examples, a thickness of the composite thin film is 200 nm±50 nm.

In some implementations, the hydrophobic sensor cover is used for a light detection and ranging (lidar) sensor.

According to another aspect, a method for manufacturing a hydrophobic sensor cover includes depositing a metal and a dielectric material on a base plate to thereby form, on the base plate, a composite thin film including metal nanoparticles that are dispersed in the dielectric material.

Implementations according to this aspect can include one or more of the following features and the features described above. For example, the composite thin film may have a metastructure including nano-columns that are arranged in the composite thin film. In some implementations, the metal and the dielectric material are simultaneously deposited on the base plate using a glancing angle deposition (GLAD) process.

In some implementations, the method may include depositing a self-assembly monolayer (SAM) film on a surface of the metastructure.

In some examples, the dielectric material may include at least one of SiO₂, TiO₂, ZnO, HfO₂, or MgF₂, and the metal nanoparticles may include at least one of Al, Cu, Pt, Ag, Ni, Au, Pd, or Mg.

The hydrophobic lidar cover may have super-hydrophobic properties while maintaining near-infrared transmission performance, thereby preventing contamination by water-based contaminants.

Therefore, the hydrophobic lidar cover may increase the detection accuracy of lidar-based autonomous vehicles, so it is expected to make a contribution to the safety improvement and commercialization of autonomous vehicles.

In addition, the hydrophobic lidar cover has high productivity and low cost because the hydrophobic lidar cover may mass-produced at wafer-scale through a simple process without lithography. Furthermore, it is expected to further accelerate the miniaturization trend of lidar by improving the fuel efficiency of autonomous vehicles with a solution to deal with the problem of difficult miniaturization and heavy weight of moisture-proof/water-proof devices that use conventional power sources.

### BRIEF DESCRIPTION OF THE DRAWINGS

FIG. 1 is a schematic diagram illustrating an example of a composite thin film of a hydrophobic light detection and ranging (lidar) cover.

FIG. 2 illustrates materials for the composite thin film, and respective refractive indices and transmittances of the materials.

FIG. 3 is a schematic diagram illustrating a metastructure of the hydrophobic lidar cover.

FIGS. 4 to 7 illustrate an example of a manufacturing process of the hydrophobic lidar cover.

FIG. 8 illustrates super-hydrophobic properties of the metastructure.

FIG. 9 illustrates the phenomenon of plasmonic resonance caused by metal nanoparticles.

FIG. 10 illustrates transmittance characteristics of an example of a composite thin film.

FIG. 11 illustrates an example of metal materials for the cover.

FIGS. 12 to 14 illustrate the reflectivity, transmittance, and absorptivity of the metal materials of FIG. 11.

FIG. 15 illustrates the optical response of visible light and near-infrared light as a function of reflectivity, transmittance, and absorptivity of the metal material of FIG. 11.

FIG. 16 illustrates an example of a dielectric material for the cover.

FIGS. 17 to 19 illustrate the reflectivity, transmittance, and absorptivity of the dielectric material of FIG. 16.

FIG. 20 illustrates the optical response of visible light and near-infrared light as a function of reflectivity, transmittance, and absorptivity of the dielectric material of FIG. 16.

FIG. 21 illustrates an example of a volume ratio of metal nanoparticles.

FIGS. 22 to 24 illustrate the reflectivity, transmittance, and absorptivity of the metal nanoparticles of FIG. 21.

FIG. 25 illustrates the optical response of visible light and near-infrared light as a function of reflectivity, transmittance, and absorptivity of the metal nanoparticles of FIG. 21.

FIG. 26 illustrates an example of a thickness range of the composite thin film for the cover.

FIGS. 27 to 29 illustrate the reflectivity, transmittance, and absorptivity of the composite thin film of FIG. 26.

FIG. 30 illustrates the optical response of visible light and near-infrared light as a function of reflectivity, transmittance, and absorptivity of the composite thin film of FIG. 26.

FIG. 31 illustrates the materials and factors of the composite thin film.

FIGS. 32 to 35 respectively illustrate the optical responses of the metal material, dielectric material, metal nanoparticles volume ratio, and composite thin film thickness range.

FIG. 36 illustrates an example of a model describing a contact angle.

FIG. 37 illustrates the optical response of the composite thin film as a function of thickness of the composite thin film.

FIGS. 38 to 40 respectively illustrate the reflectivity, transmittance, and absorptivity as a function of wavelength by thickness.

FIG. 41 illustrates an example of a temperature variation as a function of thickness of the composite thin film.

FIG. 42 illustrates an example of a visible light absorption rate as a function of temperature variation.

FIG. 43 illustrates a visible light absorption rate as a function of time of temperature increase of 5° C.

FIG. 44 illustrates an example of a wavelength-specific reflectance of the metastructure.

FIG. 45 illustrates an example of a wavelength-specific transmittance of the metastructure.

FIG. 46 illustrates a comparison of the photothermal properties of the metastructure.

FIGS. 47 to 49 illustrate an example of humidity test results.

### DETAILED DESCRIPTION

In order to fully appreciate the purpose, operation, and operational advantages of the present disclosure, reference should be made to the accompanying drawings, which illustrate example implementations of the present disclosure, and to the description thereof.

In describing implementations of the present disclosure, any description or repetition of the disclosure that would obscure the essence of the present disclosure is hereby reduced or omitted.

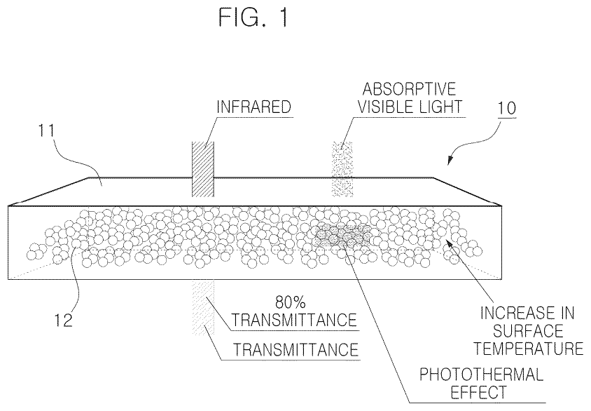

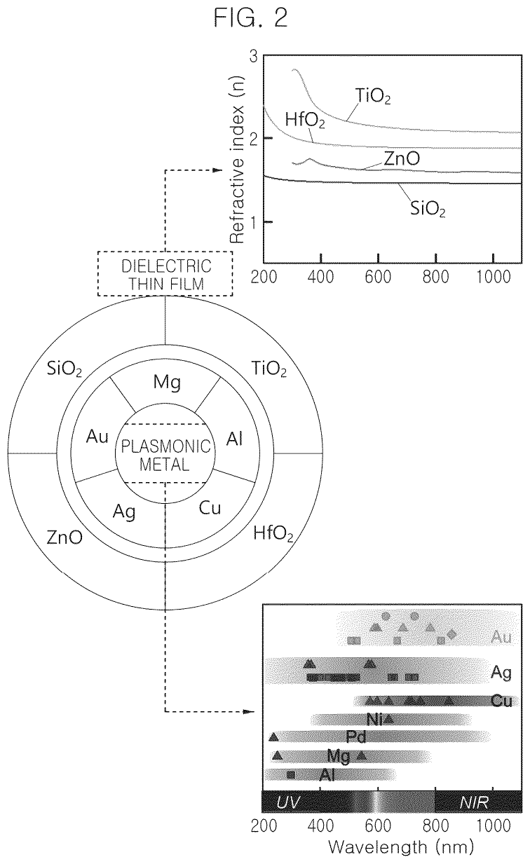

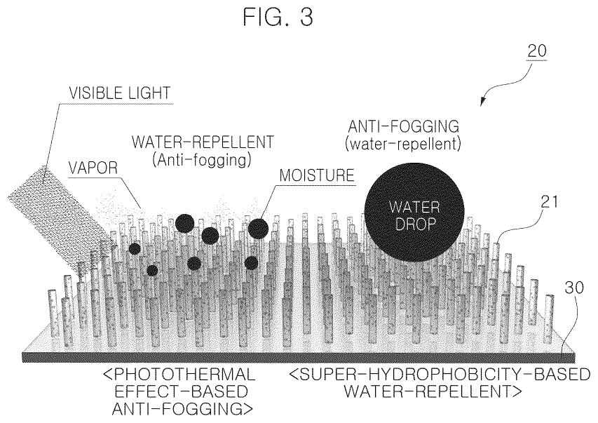

FIG. 1 is a schematic diagram illustrating a composite thin film of a hydrophobic light detection and ranging (lidar) sensor cover, FIG. 2 illustrates example materials for the composite thin film, and respective refractive indices and transmittances of the materials, and FIG. 3 is a schematic diagram illustrating an example of a metastructure of the hydrophobic lidar cover.

Hereinafter, a hydrophobic lidar cover and a manufacturing method thereof will be described with reference to FIGS. 1 to 3.

The present disclosure relates to a lidar cover utilizing a super-hydrophobic photothermal meta-surface having both moisture-proof and water-repellent properties.

To achieve powerless anti-fogging and improved water repellency, the lidar cover may be provided with a protrusion structure having a super-hydrophobic property to provide water-repellent capability and formed of a metamaterial having a photothermal effect. These two functions may be implemented in a single layer to minimize near-infrared transmittance performance and to simplify the manufacturing process to reduce costs.

In some implementations, the hydrophobic lidar cover includes a base plate 30 and a metal-dielectric composite thin film 10 that includes metal nanoparticles 12 dispersed in a dielectric material 11.

For example, the metal-dielectric composite structure including the metal nanoparticles 12 selectively absorbs a visible range of light of sunlight to produce a photothermal effect to remove moisture, as illustrated in FIGS. 1 and 2. The metal-dielectric composite structure also selectively transmits near-infrared range light to reduce distortion of the lidar signal.

In some implementations, the dielectric material 11 may include SiO₂, TiO₂, ZnO, HfO₂, or MgF₂, and the metal nanoparticles 12 may include a plasmonic metal, such as Al, Cu, Pt, Ag, Ni, Au, Pd, or Mg.

The optical properties of the metal-dielectric composite structure may be tuned depending on the types of metal materials and oxides, which constitute the nanocomposite, as illustrated in FIG. 2. The present disclosure employs copper and silicon dioxide (SiO₂) to achieve visible light range absorption for photothermal effects and high transmittance at a 905 nm wavelength used in lidar. However, the plasmonic metal having optical reactivity in the visible light range, such as gold or silver, may also have similar effects. Depending on metal and dielectric properties employed for the fabrication of the nanocomposite, lidar of various wavelengths, such as not only 905 nm, but also 940 nm, 1550 nm, or the like, may be applied.

In some implementations, as illustrated in FIG. 3, the metal-dielectric composite thin film may be designed and fabricated into a metastructure 20 including nano-columns 21 to provide the same optical properties and photothermal effects as the thin film structure in individual 3D structures.

For example, a super-hydrophobic photothermal meta-surface of the metastructure 20 may have the structural characteristics of a periodic arrangement of such metal-dielectric composite nanostructures. This structure exhibits super-hydrophobicity to provide water resistance. Therefore, the super-hydrophobic photothermal meta-surface may achieve both moisture-proof and waterproof properties with the photothermal effects of the material and the super-hydrophobicity of the structure.

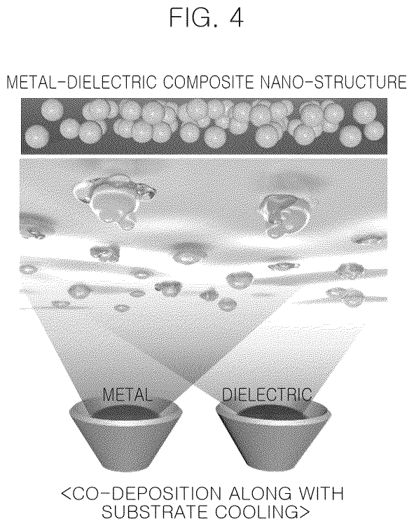

FIGS. 4 to 7 illustrate an example of a manufacturing process of the hydrophobic lidar cover.

In some implementations, the metal-dielectric composite nanostructure or metastructure 20 may be fabricated by co-depositing metal and oxide as illustrated in FIG. 4 through a physical vapor deposition (PVD) method to produce a structure in which metal nanoparticles are dispersed in the oxide. This is possible due to the immiscible nature of the metal and oxide.

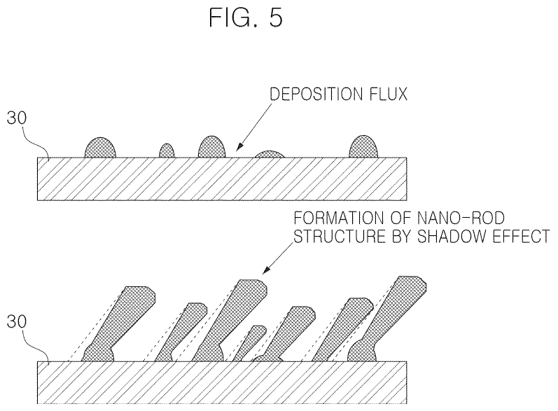

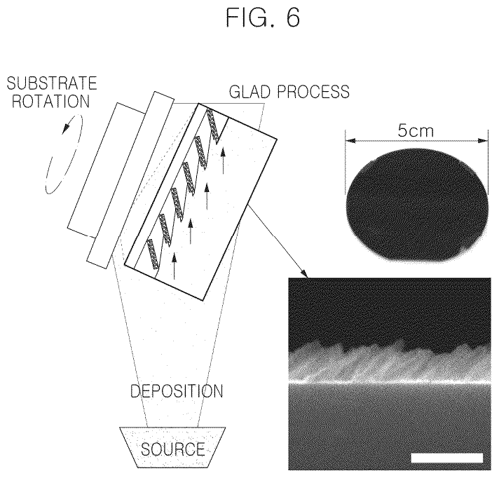

As illustrated in FIGS. 5 and 6, a super-hydrophobic photothermal meta-surface is fabricated by glancing angle deposition (GLAD).

The GLAD is a method that may fabricate a 3D nanostructure in a large area (>2 inches) through the control of the angle and rotation speed of a substrate. When the substrate 30 is tilted with respect to the deposition flux, there are regions where particles are not deposited, which is called a shadow effect. With this shadow effect, various structures such as nano-columns, helixes, and porous structures may be fabricated in a large surface area through the control of the tilt and rotation of the substrate. In the present disclosure, a metal-dielectric composite nano-rod array structure is fabricated by simultaneously depositing metal and oxide while rotating the substrate rapidly.

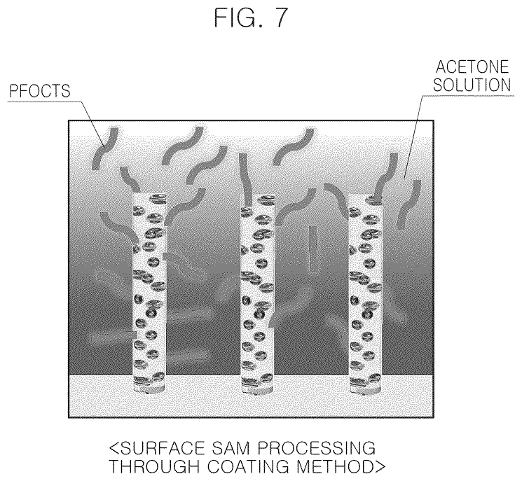

Subsequently, the fabricated nanostructure is processed with acetone and trichloro(1H,1H,2H,2H-perfluorooctyl)silane (PFOCTS), as illustrated in FIG. 7, to form a self-assembly monolayer (SAM) film. PFOCTS is a biocompatible polymer capable of lowering surface energy, so PFOCTS may be used in surface modification to form SAM on the nanostructure to make the meta-surface super-hydrophobic.

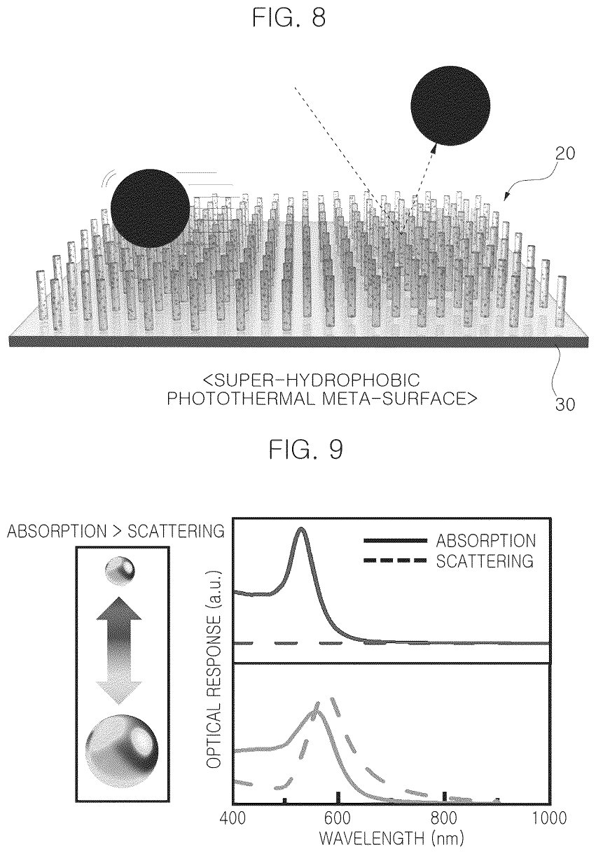

This allows the metastructure 20 to have a super-hydrophobic photothermal meta-surface as illustrated in FIG. 8.

Referring to FIG. 9, the metal nanoparticles exhibit the phenomenon of Localized Surface Plasmon Resonance (LSPR), which causes absorption and scattering of light at a selectable wavelength. In particular, when the metal nanoparticles have the particle size of about 10 nm or less, the scattering of light is almost extinguished and only the absorption is strongly expressed, maximizing the wavelength-specific photothermal effect.

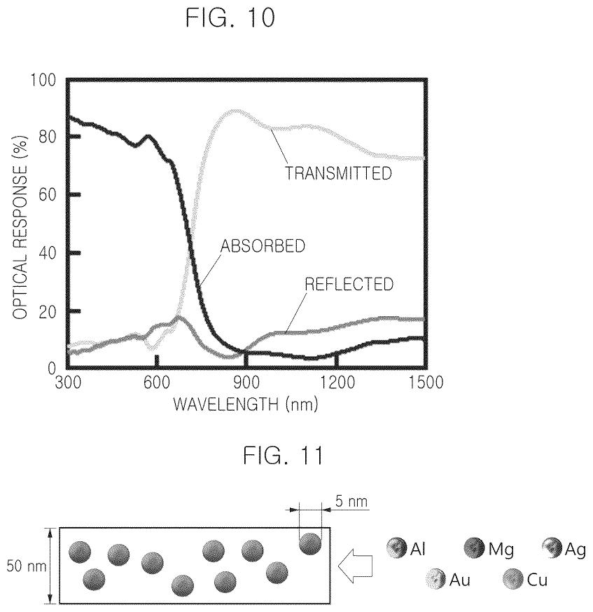

Referring to FIG. 10, a structure in which copper nanoparticles of less than 10 nm in particle size are dispersed in a dielectric selectively absorbs only wavelengths in the visible range and has high transmittance in the near-infrared range. This enables powerless moisture-proofing using sunlight without distorting the lidar signal.

In some cases, an Au—TiO₂ nanofilm may remove moisture at a temperature increase of 5° C. through the photothermal effect of sunlight absorption.

For example, the meta-surface has an absorption rate of 20% (up to 91 W/m²) in the visible range and 36.9% (up to 196 W/m²) in the near-infrared range, absorbing about 29% (up to 287 W/m²) of the total solar energy (1000 W/m²) at AM 1.5 G. The present disclosure aims to produce a photothermal effect by absorbing visible light, which accounts for about 42% (up to 420 W/m²) of total solar energy, through a regional wavelength absorption. The present disclosure is capable of absorbing 60% or more (>280 W/m²) of the visible light range energy to achieve an improved photothermal effect over the above-noted cases, while transmitting at least 80% (1 dB reduction from the original signal) of the wavelength band in the 905 nm range to minimize lidar signal distortion.

Hereinafter, the material properties for realizing the meta-surface will be described.

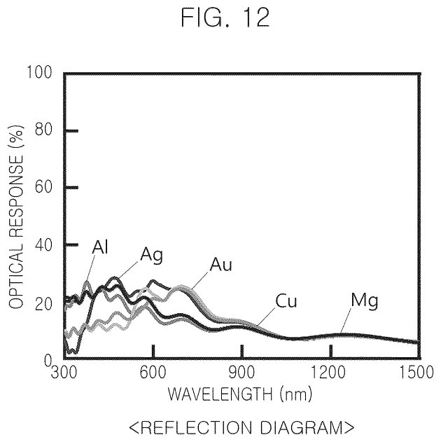

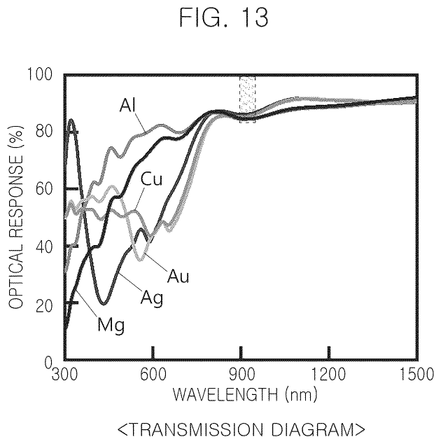

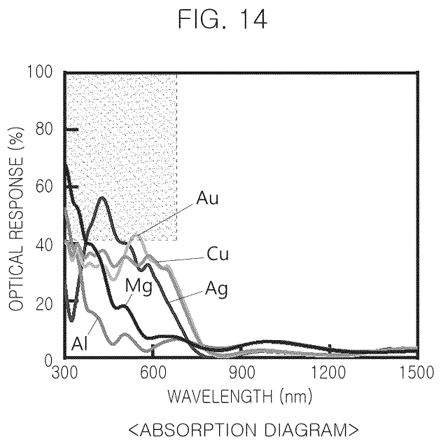

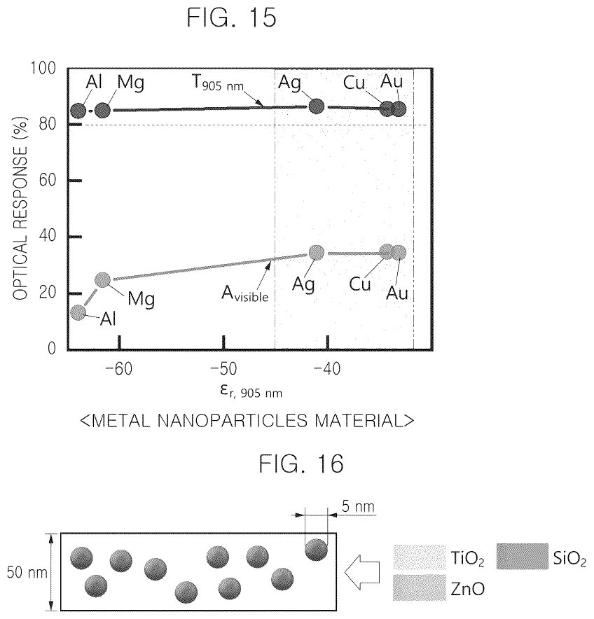

FIG. 11 illustrates a metal material, FIGS. 12 to 14 illustrate the reflectivity, transmittance, and absorptivity of the metal material of FIG. 11, and FIG. 15 illustrates the optical response of visible light and near-infrared light as a function of reflectivity, transmittance, and absorptivity of the metal material of FIG. 11.

As a result of simulating a plasmonic metal (Al, Mg, Ag, Au, or Cu) as the metal nanoparticles 12 as variables, the transmittance at 905 nm exceeded 80%, but a large difference occurred in the absorption in the visible light range, which affects the photothermal effect. The high absorption of Ag, Au, or Cu in the visible range suggests that all three materials may be utilized for a lidar-dedicated photothermal meta-surface, and Cu may be used from a cost perspective.

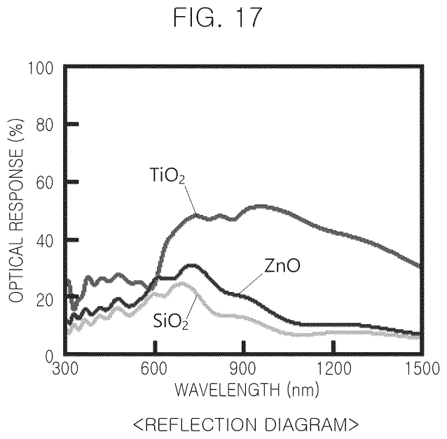

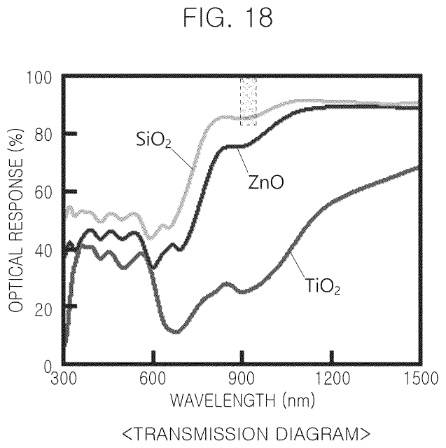

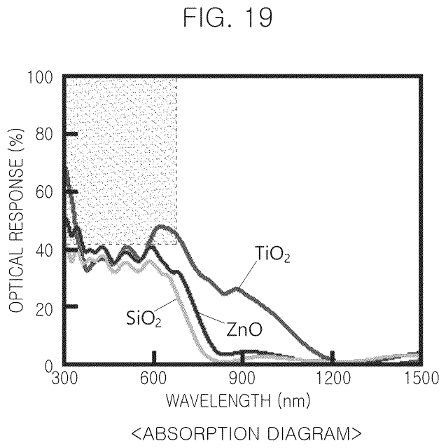

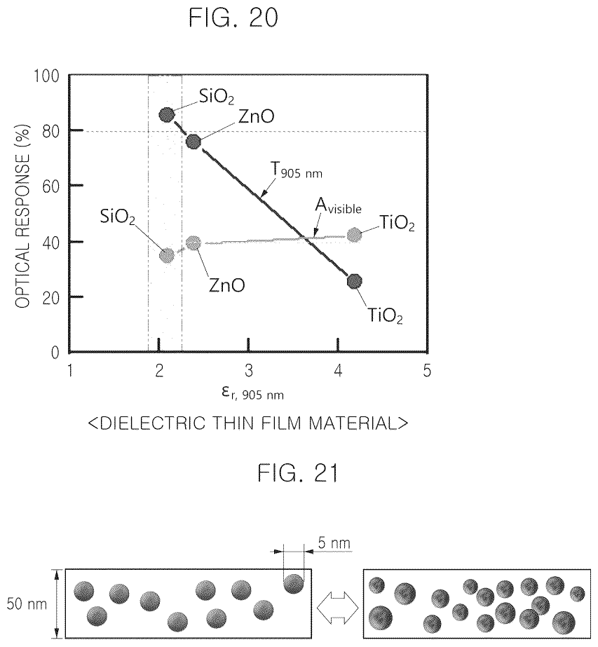

FIG. 16 illustrates a dielectric material, FIGS. 17 to 19 illustrate the reflectivity, transmittance, and absorptivity of the dielectric material of FIG. 16, and FIG. 20 illustrates the optical response of visible light and near-infrared light as a function of reflectivity, transmittance, and absorptivity of the dielectric material of FIG. 16.

To determine the optical properties of the meta-surface as a function of permittivity, a dielectric thin film deposited around Cu particles was simulated as a variable. An example transparent dielectric material is SiO₂, Al₂O₃, HfO₂, ZnO, TiO₂, or the like. The higher the dielectric permittivity of the dielectric material, the higher the wavelength and intensity of the plasmonic effect, but if the permittivity is too high, the photo-responsive wavelength band extends into the NIR range, resulting in low 905 nm transmittance. Therefore, a dielectric material with a suitable degree of permittivity may be adopted, and the simulation results are based on SiO₂ with low permittivity, ZnO with a medium permittivity, and TiO₂ with high permittivity. The absorption in the visible range was 34.5% for SiO₂, 39.1% for ZnO, and 41.9% for TiO₂, showing that the higher the permittivity, the higher the absorption under the same conditions. However, higher permittivity causes greater reflection of light, so the 905 nm transmittance of the meta-surface decreases to 85% for SiO₂, 75% for ZnO, and 25% for TiO₂. The present disclosure describes examples having a high transmittance in the 905 nm wavelength band, where SiO₂ may be employed, for instance.

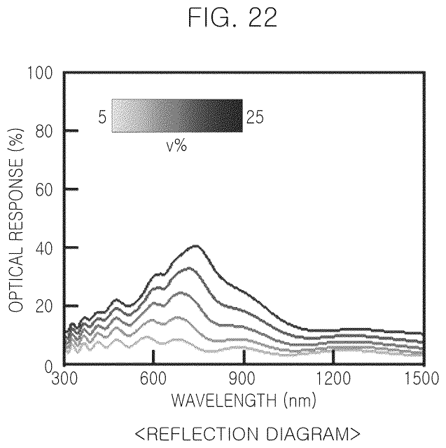

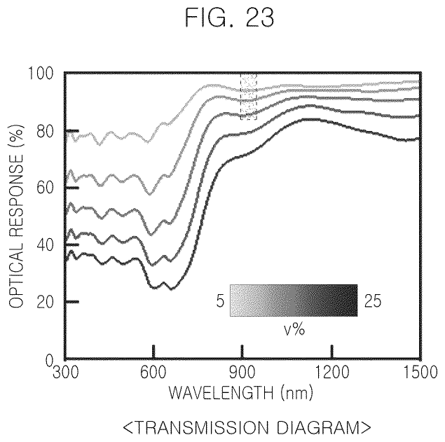

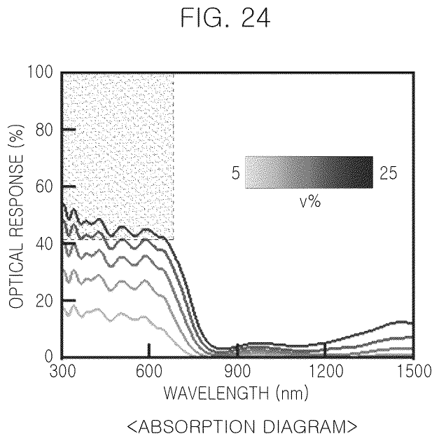

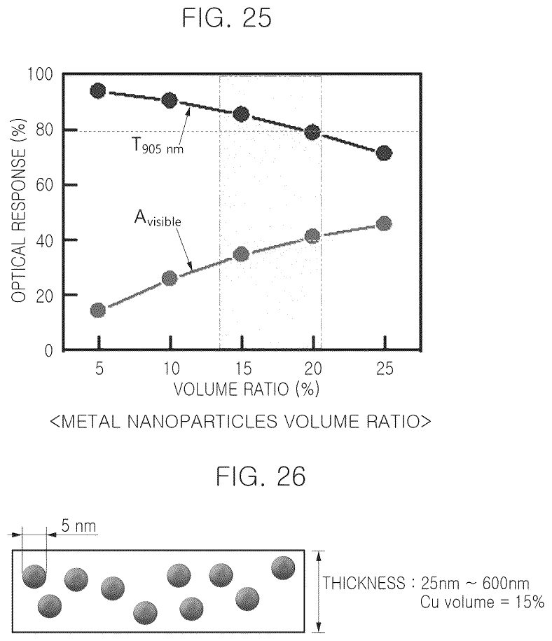

FIG. 21 illustrates a volume ratio of metal nanoparticles, FIGS. 22 to 24 illustrate the reflectivity, transmittance, and absorptivity of the metal nanoparticles of FIG. 21, and FIG. 25 illustrates the optical response of visible light and near-infrared light as a function of reflectivity, transmittance, and absorptivity of the metal nanoparticles of FIG. 21.

Simulations were conducted to optimize the metal nanoparticle volume ratio using Cu—SiO₂, which is the optimal combination selected through the previous simulations. As the volume ratio of the metal nanoparticles 12 increases, the reflection and absorption in the visible range increases, and the transmittance in the 905 nm wavelength band decreases. In the present disclosure, 15±5% with a high visible light absorption efficiency while maintaining a transmittance of 905 nm above 80% is considered as an optimal condition for minimizing lidar signal loss.

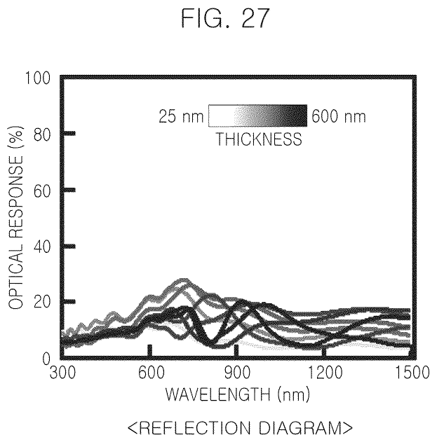

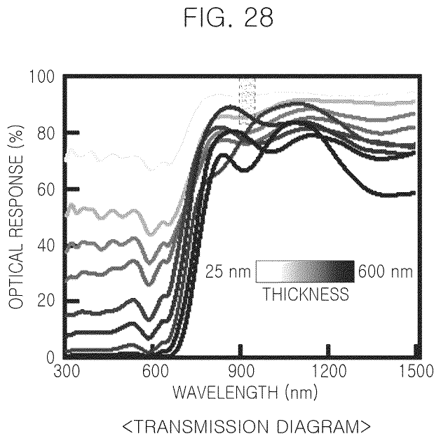

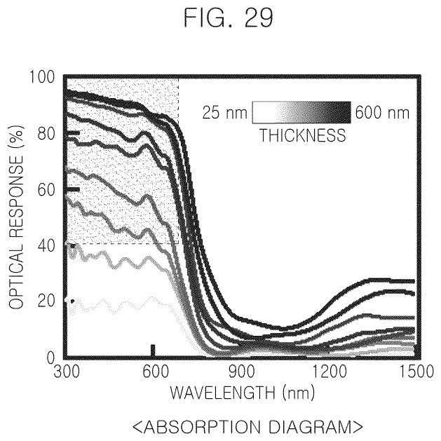

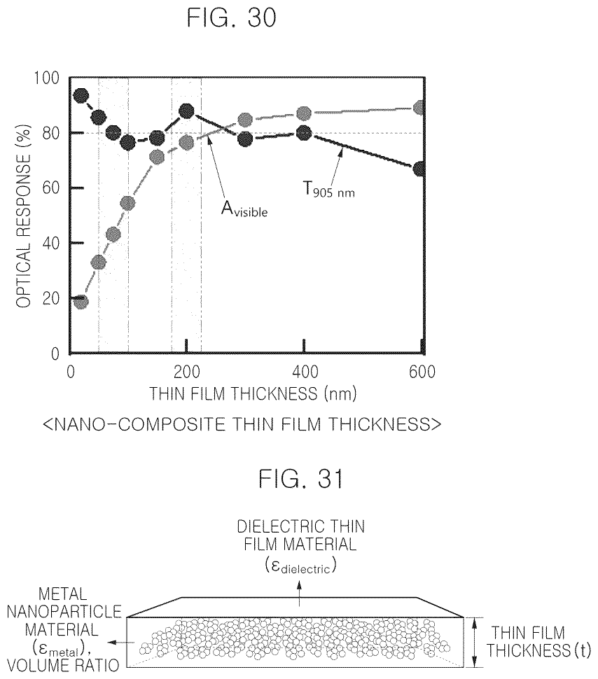

FIG. 26 illustrates a thickness range of a composite thin film, FIGS. 27 to 29 illustrate the reflectivity, transmittance, and absorptivity of the composite thin film of FIG. 26, and FIG. 30 illustrates the optical response of visible light and near-infrared light as a function of reflectivity, transmittance, and absorptivity of the composite thin film of FIG. 26.

As the thickness of the thin film increases, the absorption in the visible range increases, but the transmittance at 905 nm fluctuates with thickness due to an optical interference phenomenon. The simulation results show that when the thickness is 200 nm, the 905 nm transmittance is 87% and the visible light range has a high absorption of 76%, so 200 nm±50 nm may be set as the optimal condition.

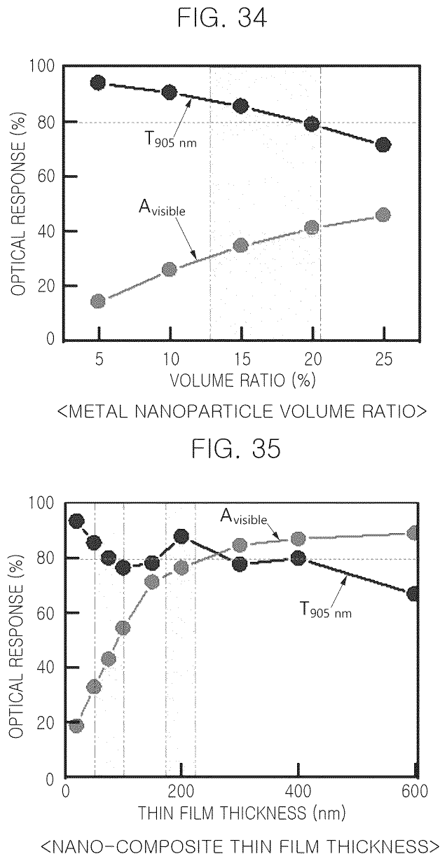

These design conditions may be summarized in conclusion from FIG. 31 to FIG. 35.

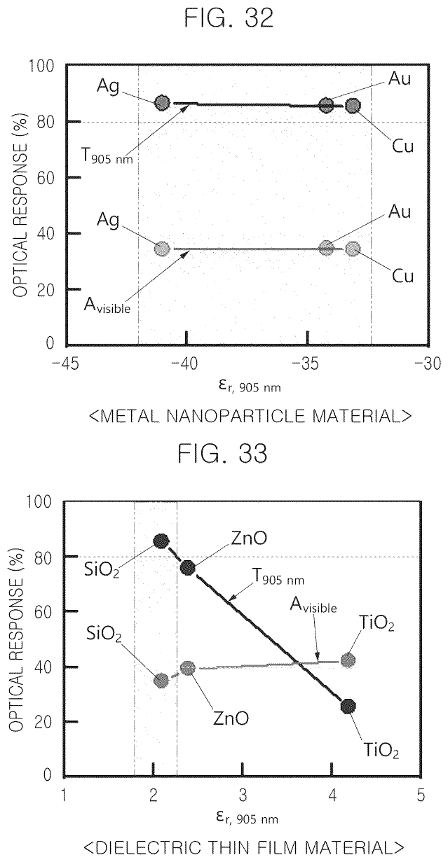

FIG. 31 illustrates the materials and factors of the composite thin film, and FIGS. 32 to 35 respectively illustrate the optical responses of the metal material, dielectric material, metal nanoparticles volume ratio, and composite thin film thickness range.

The present disclosure enables controllable optical properties through parameter manipulation of the metal-dielectric material and structure of the meta-surface. To apply this to a moisture-proof meta-surface dedicated for lidar, a theoretical design of a meta-surface with high near-infrared transmittance along with visible light absorption capability was carried out. The results show that the optimized structure is a nanostructured composite of 200 nm thick Cu particles (15% by volume) and SiO₂ thin film, which achieves 87% transmittance at 905 nm and 76% absorption of visible light.

The water-proof function will now be further described with reference to the contact angle model in FIG. 36.

Young's state is a model that describes the contact angle between a liquid droplet and a solid surface on a flat surface. Depending on the surface roughness, the contact angle may be modeled by Wenzel's state and Cassie-Baxter state, and especially, the Cassie-Baxter state is the state that appears when the surface is very rough and porous so that the contact between the liquid and the surface is minimized and thus the liquid remains in a substantially spherical shape, providing super-hydrophobicity. In the Cassie-Baxter state, water droplets have a high contact angle (150 degrees or more), which provides water-proof properties.

In some embodiments, the skin of the gecko lizard has micro/nano-sized spiny protrusions, which form a Cassie-Baxter state on the skin surface. Therefore, in the present disclosure, a super-hydrophobic surface exhibiting a Cassie-Baxter state may be realized by SAM treatment on a meta-surface made into a nano-array structure imitating the skin of the gecko lizard.

The optical properties of the metal-dielectric composite thin film are shown in the following.

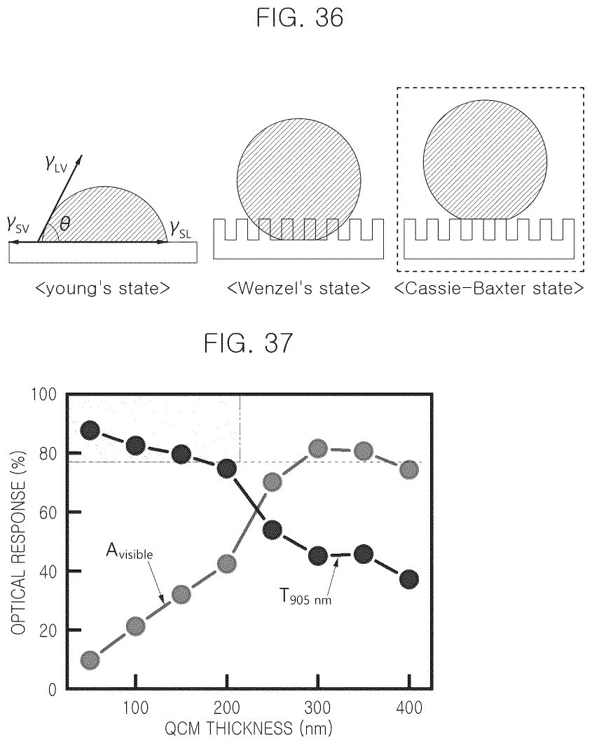

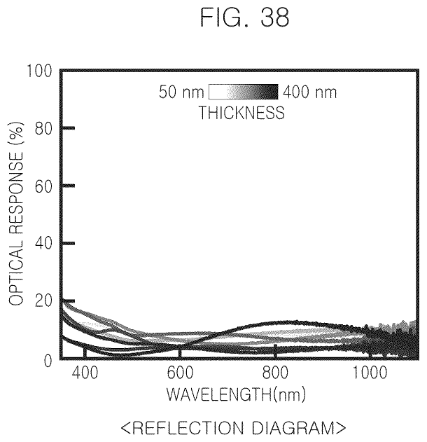

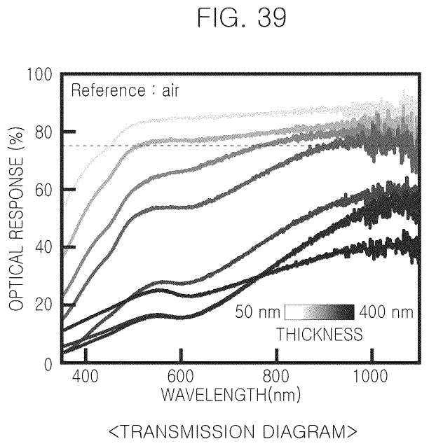

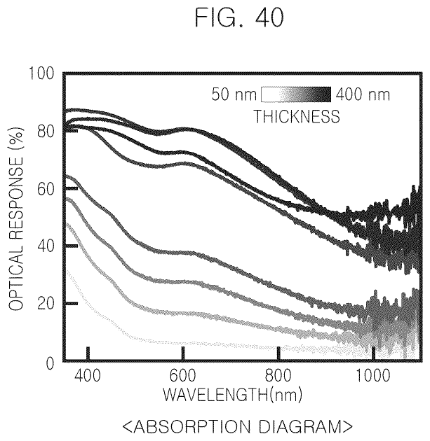

FIG. 37 illustrates the optical response of the composite thin film as a function of thickness of the composite thin film, and FIGS. 38 to 40 respectively illustrate the reflectivity, transmittance, and absorptivity as a function of wavelength by thickness. Thin films of the metal-dielectric composite (Cu:SiO₂=2:3 composite, t=50-400 nm on low iron glass) were fabricated according to a thickness ranging from 50 nm to 400 nm, and the optical properties were confirmed. In the film thickness range of 150 to 200 nm, a 905 nm wavelength transmittance of 80% or more compared to glass (74% compared to air) and selective absorption of visible range light were confirmed. In some embodiments, manipulation of metal-dielectric material and process parameters may be used to control the absorption and transmittance in the desired wavelength range, allowing the design of meta-surface with desired optical properties.

The thermal properties of metal-dielectric composite with a thickness ranging from 50 nm to 400 nm are shown in the following.

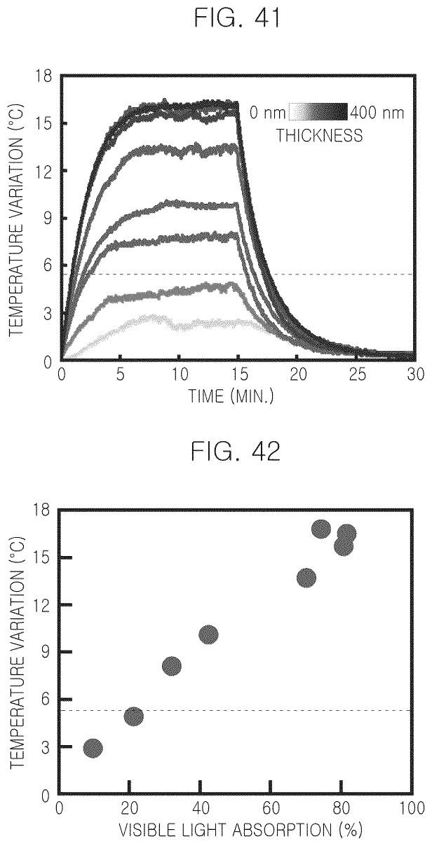

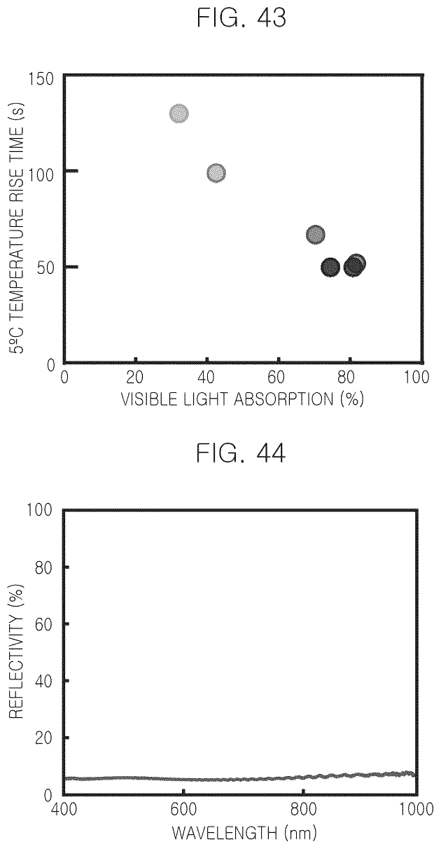

FIG. 41 illustrates a temperature variation as a function of thickness of the composite thin film, FIG. 42 illustrates a visible light absorption rate as a function of temperature variation, and FIG. 43 illustrates a visible light absorption rate as a function of time of temperature increase of 5° C.

The photothermal characteristics of the meta-surface by thickness were checked with a thermocouple using a solar simulator at an illumination of 1 sun (979 W/m²) as a light source. A surface temperature difference due to the photothermal effect was up to 16.8° C., which was higher than the 5° C. suggested in some cases on moisture removal by the photothermal effect. As the thickness of the meta-surface increases, the visible light absorption rate increases, and the tendency of temperature increase also increases with the increase in visible light absorption rate.

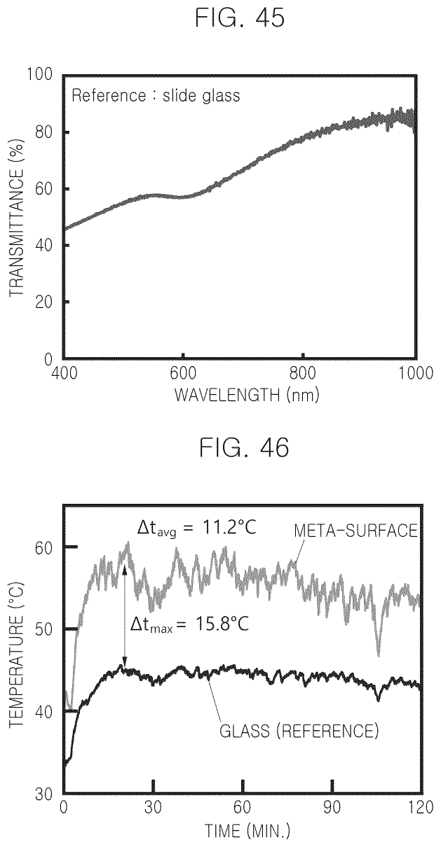

Then, a 150 nm thick Cu—SiO₂ composite meta-surface was deposited on the slide glass for photothermal and moisture-proof properties experiments. Referring to FIGS. 44 and 45, the 905 nm transmittance of the fabricated meta-surface was measured to be 84% compared to the slide glass, and the visible light absorption rate was approximately 38%.

To verify the photothermal properties of the meta-surface under sunlight, an outdoor photothermal experiment was performed on the fabricated meta-surface. The measurement time was two hours from 1 p.m, to 3 p.m., with an ambient temperature of 38.7° C. and humidity of 42.2%. During the measurement time, the solar radiation was between 900 W/m² and 700 W/m², which was similar to the solar radiation (up to 1000 W/m²) at AM1.5 G. Referring to FIG. 46, it could be seen from the experimental results that the maximum temperature was increased by 15.8° C. due to the photothermal effect, which was higher than 5° C. as a target value.

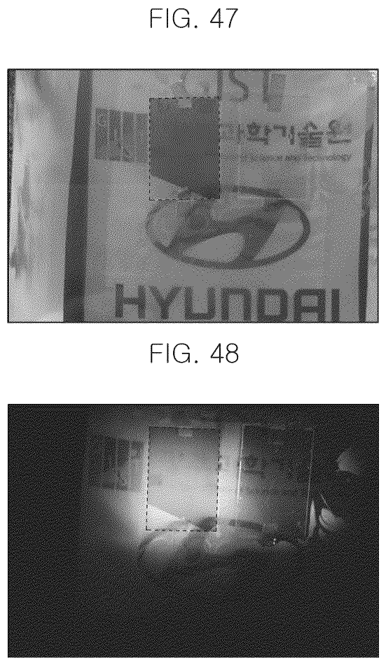

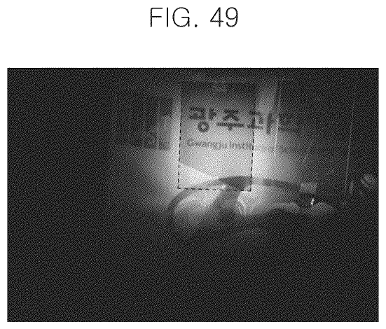

FIGS. 47 to 49 illustrate humidity test results. A halogen light source was used to check the moisture removal performance of the meta-surface at 0.5 sun radiation. After saturating the humidity of the environment inside an acrylic chamber (humidity: 96.4%, air temperature: 20.4° C.) (FIG. 47), the chamber was continuously moisturized by irradiating light. At first, the letters were not visible, but after 5 minutes (FIG. 48), some moisture was removed, and after 10 minutes (FIG. 48), it could be seen that the moisture was completely removed from the meta-surface.

As described above, the super-hydrophobic photothermal meta-surface enables the powerless moisture-proof function (anti-fogging) in the lidar cover, super-hydrophobicity using the protrusion structure (enhanced water repellency), and moisture-proof and water-repellent functions in a single layer (minimized near-infrared light loss, simplified process).

While the foregoing disclosure has been described with reference to the illustrative drawings, it will be apparent to those of ordinary skill in the art that it is not limited to the embodiments described, and that various modifications and variations may be made without departing from the spirit and scope of the present disclosure.

Accordingly, such modifications or variations should be considered as falling within the scope of the claims of the present disclosure, and the claims of the present disclosure should be construed based on the appended claims.

What is claimed is:

1. A hydrophobic sensor cover comprising:
a base plate; and
a composite thin film deposited on the base plate,
wherein the composite thin film comprises metal nanoparticles that are dispersed in a dielectric material.

2. The hydrophobic sensor cover of claim 1, wherein the dielectric material comprises at least one of SiO₂, TiO₂, ZnO, HfO₂, or MgF₂.

3. The hydrophobic sensor cover of claim 1, wherein the metal nanoparticles comprise a plasmonic metal.

4. The hydrophobic sensor cover of claim 1, wherein the metal nanoparticles comprise at least one of Al, Cu, Pt, Ag, Ni, Au, Pd, or Mg.

5. The hydrophobic sensor cover of claim 1, wherein the dielectric material comprises at least one of SiO₂, TiO₂, ZnO, HfO₂, or MgF₂, and
wherein the metal nanoparticles comprise at least one of Al, Cu, Pt, Ag, Ni, Au, Pd, or Mg.

6. The hydrophobic sensor cover of claim 1, wherein the dielectric material comprises SiO₂, and the metal nanoparticles comprise Cu.

7. The hydrophobic sensor cover of claim 1, wherein the composite thin film has a metastructure including nano-columns that are arranged in the composite thin film.

8. The hydrophobic sensor cover of claim 7, wherein the metastructure comprises a self-assembly monolayer (SAM) film that is deposited on a surface of the metastructure.

9. The hydrophobic sensor cover of claim 1, wherein a volume of the metal nanoparticles is 15±5% of a total volume of the dielectric material.

10. The hydrophobic sensor cover of claim 1, wherein a thickness of the composite thin film is 200 nm±50 nm.

11. A light detection and ranging (lidar) sensor comprising the hydrophobic sensor cover of claim 1.

12. A method for manufacturing a hydrophobic sensor cover, the method comprising:
depositing a metal and a dielectric material on a base plate to thereby form, on the base plate, a composite thin film including metal nanoparticles that are dispersed in the dielectric material.

13. The method of claim 12, wherein the composite thin film has a metastructure including nano-columns that are arranged in the composite thin film.

14. The method of claim 13, wherein the metal and the dielectric material are simultaneously deposited on the base plate using a glancing angle deposition (GLAD) process.

15. The method of claim 14, further comprising depositing a self-assembly monolayer (SAM) film on a surface of the metastructure.

16. The method of claim 12, wherein the dielectric material comprises at least one of SiO₂, TiO₂, ZnO, HfO₂, or MgF₂, and
wherein the metal nanoparticles comprise at least one of Al, Cu, Pt, Ag, Ni, Au, Pd, or Mg.

17. The method of claim 12, wherein a volume of the metal nanoparticles is 15±5% of a total volume of the dielectric material.

18. The method of claim 12, wherein a thickness of the composite thin film is 200 nm±50 nm.
